(19) United States
(12) Patent Application Publication
(10) Pub. No.: US 2004/0068502 A1
(43) Pub. Date: Apr. 8, 2004

(54) Context information management in a communication device

(76) Inventors: Jerome Vogedes, Wind Lake, WI (US); Michael Kotzin, Buffalo Grove, IL (US); Ariel Pashtan, Buffalo Grove, IL (US); Joseph Wodka, Hoffman Estates, IL (US)

Correspondence Address: MOTOROLA, INC., 1303 EAST ALGONQUIN ROAD, IL01/3RD, SCHAUMBURG, IL, 60196

(21) Appl. No.: 10/263,446

(22) Filed: Oct. 2, 2002

(51) Int. Cl. G06F 17/30; G06F 7/00

(52) U.S. Cl. 707/9; 707/10

(57) ABSTRACT

A method (200) for context information management in a communication device includes a first step (202) of providing contextual information in the communication device that can be downloaded by a content provider. A next step (208) includes assigning access limitations to the contextual information. A next step (218) includes filtering a request for contextual information from a content provider with the access limitations from the previous step to identify contextual information that is permissible to be downloaded. A next step (220) includes sending the identified permissible contextual information to the content provider.

### FIELD OF THE INVENTION

The present invention generally relates to controlling information in a communication device. More particularly, the present invention relates to managing contextual information in a communication device.

### BACKGROUND OF THE INVENTION

New radiotelephone features and standards are dramatically elevating phone functions, over and above that of telephone conversations alone. Such new features and functions include Internet browser capability, wireless multimedia, smart phones and videophones, for example. These requirements are provided through various data services and protocols. High speed packet data, data and image processing, Global System for Mobile Communications (GSM), General Packet Radio Service (GPRS), Enhanced Data for Global Evolution (EDGE), 3rd Generation mobile data services for the Universal Mobile Telephone Service (UMTS), Global Positioning System (GPS) service, local connectivity services to a computer or peripherals, multimedia cards, and multiple high processing functions all require the radiotelephone to process and present the received data information into a convenient or preferred format for a user. Such formatting is provided by parameters defining the contextual information of the radiotelephone.

A plethora of contextual information is available on a communication device and there are no current means to address multiple entities that wish to use this information. Moreover, content providers are unaware of the ultimate use and exact formatting of information provided to a user. This becomes more complicated considering the vastly different amounts of information available, along with the wide array of radiotelephones with differing capabilities, and the numerous ways that users would prefer to present this information. One option is for content providers to supply a complete set of information related to a user's request for information. However, this requires the radiotelephone to download all this information and then filter it into a desired format, which wastes data throughput. Another option is for content providers to truncate the information into an assumed format and hope that the radiotelephone of the end user can utilize the information as delivered. Of course, this may not always work, and prevents users from having the information modified to suit their tastes.

The problem resides in the domain of mobile user data services, and the transfer of information via such user data interchange services as GSM, GPRS, EDGE, UMTS, GPS, or other data services which enable the user to utilize the mobile equipment (ME) as a “data modem” of sorts, enabling access to the Internet, multimedia messages, and download of various media content. Associated with this problem is the need to provide the capability of distributing wireless contextual information that is tailored to each individual inquiry, based on the identity of the requestor, and the environment of the end user. Based on a set of rights and permissions determined by a mobile user, other individuals or mobile services may or may not be allowed to view location or other contextual information. This will enable privacy of the mobile user's context as desired.

For instance, a user of a communication device, such as a radiotelephone, may prefer that certain individuals, service or content providers have limited or restricted access to their location, environment or other contextual information. As examples of this, a corporate tracking service should not be able to access context information after business hours, or a user may prefer to restrict access to context information of their communication device to those contained in a personal contact, or “buddy” list. Therefore, it would be desirable to restrict availability of location or other contextual information of a user's communication device to an individual or service or content provider, based on a set of rights and criteria determined by a mobile user.

Accordingly, there is a need for a method and system for contextualizing the information presented to a radiotelephone. There is a further need to have permissions and access limitations associated with certain aspects of the context. In particular, these aspects would include a location or environmental context of the communication device.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 is a simplified block diagram of a communication system, in accordance with the present invention;

FIG. 2 is a simplified schematic diagram of a communication device, in accordance with the present invention; and

FIG. 3 is a flow chart for a method of context information management in a communication device, in accordance with the present invention.

### DETAILED DESCRIPTION OF A PREFERRED EMBODIMENT

The present invention provides a method and system for contextualizing the information presented to a radiotelephone. Associated with this contextual information are permissions, rights, and access limitations associated with certain aspects of the context. These permission or rights are tailored to correspond to a request from specific individuals or service or content providers. In particular, these aspects can include location, timing or environmental context of a user's communication device.

Advantageously, the present invention can be used in any mobile station or communication device, such as a radiotelephone, Personal Digital Assistant (PDA), pocket PC, or laptop computer, wherein a wireless data environment exists to deliver or allow or display contextual information of a wireless user specific to certain constraints and permissions set by the user. In particular, any provider of CDMA/GSM/3G cellular handsets or CDMA/GSM/3G subscriber units (e.g. PDAs) could use the present invention. In addition, content and application developers will also have some impact as far as essential context distribution and extensibility.

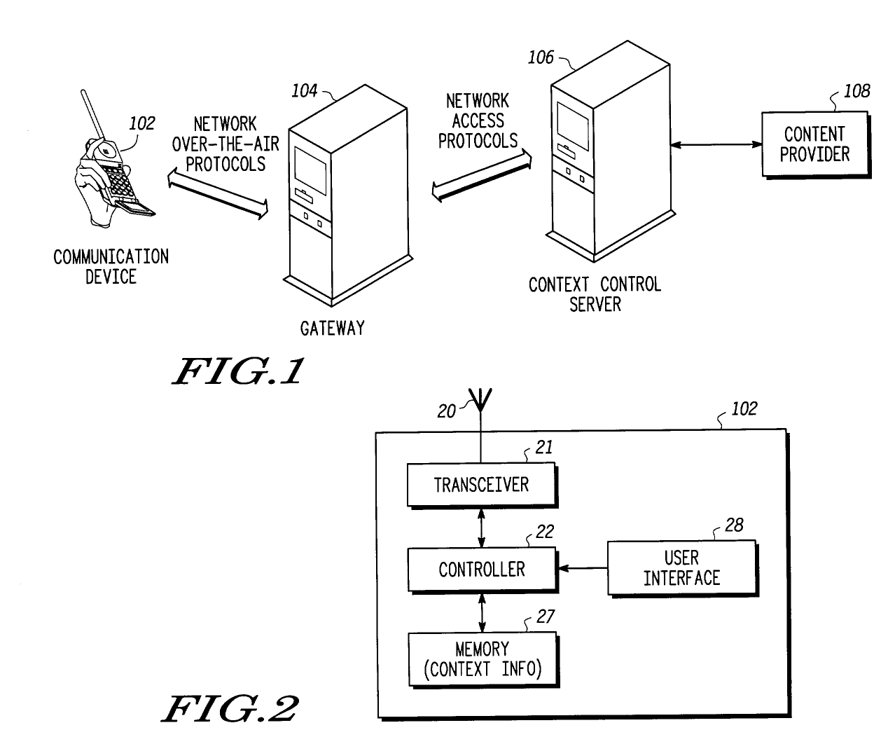

FIG. 1 presents an overview of the communication system with network and user interactions, in accordance with the present invention. The communication system 100 includes a communication device 102 (e.g. radiotelephone) and a communication infrastructure 104, 106 that facilitates communication between the communication device 102 and a content provider 108. The communication device 102 is configured for the transfer of information and data to a gateway 104 (e.g. base station) using network over-the-air protocols. This connection can be in any standard communication system and can be to a wide area network (WAN), for example. The communication device 102 can also be configured to accommodate local connectivity, such as to local area network (LAN). This connection can be wired or wireless. Individuals or service providers, generally lumped into the category of content providers 108, access the communication device 102 through a context control server 106 and gateway 104.

The communication device 102 has contextual information relating to the communication device, and can download data or applications from the gateway 104, WAN or LAN, that can be modified by the contextual information. The communication device 102 includes a user interface to present received information to the user. The communication device 102 maps access limitations to various content providers to control access to the contextual information. The communication device 102 filters requests for contextual information with the access limitations to identify contextual information that is permissible to be viewed by any particular content provider. In other words, the received information is filtered or formatted in accordance with user preferences defined by the contextual information. The user preferences (access limitations) include rules that are dependent on: the location of the communication device, the environment of the communication device, existing applications running on the communication device, and the time of day.

In operation, the communication device has predefined contextual information parameters. Existing contextual information services are extended to provide mobile users to set up various criteria to allow certain user-defined parties (e.g. specific individuals, subscribed services, service or content providers, etc.) access to their contextual information (e.g. environment, location, time). These criteria are determined by the user phone configuration and the user preferences. The access limitations can be correlated or mapped to particular content providers or specific requests by a content provider 108 that can request contextual information from the communication device for modifying content for presentation by the communication device. Further, control of access can be secure through token transfer as can be used in the network access protocols.

The actual contextual information can involve local storage of permissions/access limitations in the device 102 or remote storage of contextual information that is mapped to various entities requesting access. For example, the contextual information for a user or device can be stored remotely in the gateway 104 or context control server 106 of the communication infrastructure.

Referring to FIG. 2, the communication device 102 is typically a cellular telephone with an internal bus for connection of the internal components of the cellular telephone together and to the user interface 28. The internal bus is under control of a central processing unit (CPU) or controller 22. A memory 27 with radiotelephone control software and containing the contextual information connects to the internal bus and provides control of the functionality of the cellular telephone as well as information transfer. A radio RF subsystem connects to an antenna 20 via a transceiver 21. The radio subsystem is operated according to standard cellular telephone air interface specifications under control of the radiotelephone control software memory. The user interface 28 is also operated over the internal bus of the cellular telephone and can include input and output devices such as a microphone, a speaker, a keyboard and a display that are not shown for simplicity.

The memory 27 is arranged to contain contextual information of the communication device 102 that can be downloaded by a content provider through a communication network. The controller 22 maps access limitations to various content providers to control access to the contextual information, and filters requests for contextual information with the access limitations to identify contextual information that is permissible to be viewed by any particular content provider. The controller 22 stores the access limitations and contextual information in the memory 27, where permissible contextual information is available to be downloaded to a requester through the transceiver circuitry 20, 21 of the device 102 to the content provider. Optionally, the transmitter can send information updates requested by the content provider at various times defined by, and when permissible by, the access limitations.

In practice, the access limitations can change depending on: a location of the communication device, an environment of the communication device, existing applications running on the communication device, and a time of day. This can include a change in formatting. The user interface 28 can be used by a user to manually assign access limitations. Alternatively, access limitations can be assigned as part of an automatic operation. Preferably, the access limitations can include security protocols to limit access to contextual information in the communication device. For example, password can be used or the device can pass tokens to a requestor of context information before allowing contextual access.

The parameters or criteria for allowing contextual access are based on several user-defined preferences. One preference is defined by a location of the user or communication device. For example, a time of day can relate to where a user is located. In other words, a user will be at work or at home depending on the time of day, and this can defined a user preference (e.g. for after work hours, only family members can access context information). Another preference is defined by an environment of the user or communication device. For example, access to contextual information can be predicated on the mobile user's current context, which could be any number of things including location and environment (e.g. stationary versus moving, car versus office versus home, etc.).

Similarly, access can be defined based on another application (e.g. a date book). For example, the criteria could leverage another application on the client, such as an Instant Messaging client or date book application that could be used for this. In the case of an Instant Messaging client, for example, the user may wish to post a notification when he/she is away (e.g. presence information). The Instant Messaging client could leverage or be used in conjunction with other context information to increase the granularity of the information or update context information with only certain individuals in their contact or “buddy” list. In the case of the date book, a business application could have access to the user's date book during working hours and have access to contextual information. Another preference can include grouped or specific individuals that can have access to context information. Such preference may be further subdivided into particular informational requests from the grouped or specific individuals. Similarly, A preference can include various services or applications can have access to contextual information. Analogously, such preference may be further subdivided into particular informational requests from the service or application.

In all of the above cases, the contextual information can be partially limited. In other words, all, none, or partial contextual information of varying granularity may be specified. This can include the formatting or presentation of the contextual information (e.g. audio, visual, text). For example, a user's spouse can receive context information (such as location on a map) that shows that the user is at the office, where a business application could show the user's supervisor (using text) that the user is in a particular conference room. As another example, a business enterprise tracking application is limited to access context information during business hours only. In addition, a varying granularity of information can be made available. In the case of location, a user's location can be specified, e.g. the user is in the car or the user is at a particular address.

The parameters or criteria for the allowing contextual access can be predefined so as to be transparent to the user. Alternatively, access allowance can be prompted each time their context is requested and provisioned whether or not to allow this information to be sent. Optionally, the user can password protect access to contextual information. Similarly, an acknowledgement or token can be associated with the access allowance as well as being based on the content itself. For example, an individual requesting context information for the user would be prompted for a password or PIN, or if password is not known, request the password. This can include a user acknowledge and/or the distribution of an automated key or token separate from the contextual information. In this case, the key or token can be administered by the context control server of person-to-person application. Along these lines, the context control token can be subject to verification and can expire based on the above criteria. In addition, the contextual information and the key can be combined using a hashing algorithm distributed securely and viewed by those with the key to decode it.

In a preferred embodiment, the parameters or criteria for allowing contextual access can be restricted in the frequency of contextual updates based on the rights and permissions set forth by the user. For example, a request for contextual access can be provided with a one-time upload of information to a content provider, either immediately or at some future time, or with a set of periodic updates of contextual information, of either an indefinite number or for a preset number at periodic or variable future times.

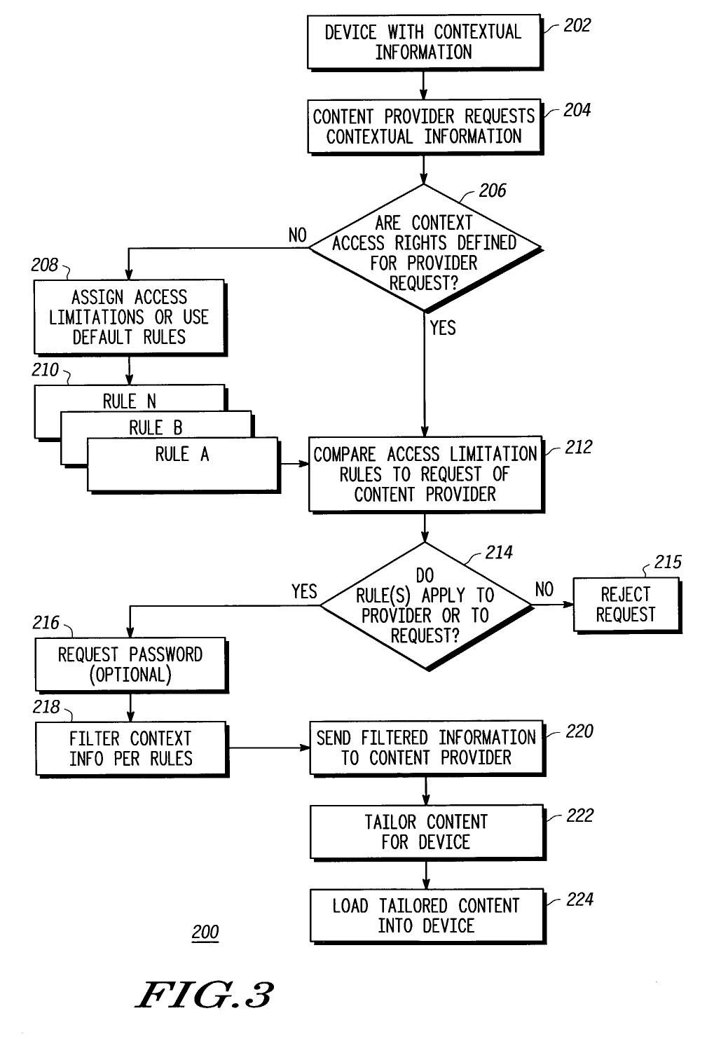

FIG. 3 shows a method for context information management in a portable communication device, in accordance with the present invention. A first step 202 includes providing contextual information in the communication device that can be downloaded by a content provider. The content provider can be defined as an individual, group of individuals, service or content provider, etc. A next step 208 includes assigning access limitations to the contextual information per content provider or provider request. Assignment includes mapping defined access limitations per provider (i.e., name or identification of provider), specific provider request, or common request among providers. The assigning step 208 can be performed as one or more of an automatic operation and as a manual operation performed by a user prompted when contextual information is requested by a content provider. A next step 218 includes filtering a request for contextual information from a content provider with the access limitations from the previous step to identify contextual information that is permissible to be viewed by the content provider. A next step 220 includes sending the identified permissible contextual information to the content provider. This can also include sending no contextual information, i.e. filtering all information out, or rejecting 215 the request. The sending step can also include sending information updates requested by the content provider at various times defined by, and when permissible by, the access limitations.

Typically, after the providing step 202, there will be a request 204 by a content provider for contextual information from the communication device. There is the option of ignoring such request or acknowledging the request with or without giving out contextual information. Normally, the access limitations can be predefined by the user for the provider or the request before the request step 204 ever occurs. Alternatively, the access limitations can be set to a default. Optionally, if no access limitations have been defined 206, the user can be prompted to assign access limitations 208 upon a request from a content provider. In this case, rules are written 210 defining the access limitations for a particular content provider or request. These rules are used in the later filtering step 218. Preferably, the access limitations in the assigning step 208 are time dependent. In other words, the rules can automatically change depending on: location of the communication device, environment of the communication device, existing applications running on the communication device, and time of day. Optionally, the access limitations in the assigning step can include a password to be requested or used by a content provider 216 to access contextual information in the communication device.

Once the rules are defined and a request is made, the present invention compares 212 the request to the rules. This includes mapping the provider request for access to the contextual information of the communication device to any access limitations that are defined as applying to that content provider, provider and request, or the request itself. If it is found during mapping that the provider or request matches a defined access limitation 214, the method proceeds with filtering 218 and sending 220 whatever full or partial contextual information is permitted, if any. However, if it is found that there is no match found during mapping, then the request is rejected 215. Alternatively, if no match is found then total information can be provided 220 (given that if a user wishes to deny all information transfer this would have been defined as an access limitation or default in the assigning step 208).

In a preferred embodiment, the present invention includes the further steps of the content provider tailoring 222 content to the contextual information received from the communication device, and loading 224 the tailored content into the communication device. The specific tailoring of information can be based on preferences of the requestor and/or the owner of the content.

As can be seen from the foregoing, the present invention provides a method and system for context information management in a communication device. While a particular embodiment of the present invention has been shown and described, modifications may be made. It is therefore intended in the appended claims to cover all such changes and modifications which fall within the broad scope of the invention.

What is claimed is:

1. A method for context information management in a communication device, the method comprising the steps of:
providing contextual information in the communication device that can be downloaded by a content provider;
assigning access limitations to the contextual information per content provider;
filtering a request for contextual information from a content provider with the access limitations from the previous step to identify contextual information that is permissible to be viewed by the content provider; and
sending the identified permissible contextual information to the content provider.

2. The method of claim 1, wherein after the providing step further comprising the step of:
requesting contextual information from the communication device by a content provider.

3. The method of claim 1, wherein the access limitations in the assigning step are time dependent.

4. The method of claim 1, wherein the access limitations in the assigning step can change depending on one or more of the group of: location of the communication device, environment of the communication device, existing applications running on the communication device, and time of day.

5. The method of claim 1, wherein the sending step includes sending information updates requested by the content provider at various times defined by, and when permissible by, the access limitations.

6. The method of claim 1, wherein the access limitations in the assigning step are rules defined per the content provider request, and wherein after the assigning step further comprising the step of mapping one or more of the content provider identification, provider and request, and the request alone to any access limitations that apply.

7. The method of claim 1, further comprising the steps of:
tailoring content to the filtered contextual information by the content provider; and
loading the tailored content into the communication device.

8. The method of claim 1, wherein the assigning step can be performed as one or more of an automatic operation and as a manual operation performed by a user prompted when contextual information is requested by a content provider.

9. The method of claim 1, wherein the access limitations in the assigning step can include security protocols to limit access to contextual information in the communication device.

10. The method of claim 1, wherein the access limitations in the assigning step can include formatting preferences.

11. A communication device with context information management the device comprising:
a memory arranged to contain contextual information of the communication device that can be downloaded by a content provider through a communication network;
a controller that maps access limitations to various content providers to control access to the contextual information, and filters requests for contextual information with the access limitations to identify contextual information that is permissible to be viewed by any particular content provider; and
a transmitter that sends identified permissible contextual information to the content provider.

12. The device of claim 11, wherein the access limitations can change depending on one or more of the group of: location of the communication device, environment of the communication device, existing applications running on the communication device, and time of day.

13. The device of claim 11, wherein the transmitter sends information updates requested by the content provider at various times defined by, and when permissible by, the access limitations.

14. The device of claim 11, further comprising a user interface, and wherein the assigning step can be performed as one or more of an automatic operation and as a manual operation performed by a user through the user interface.

15. The device of claim 11, wherein the access limitations can include security protocols to limit access to contextual information in the communication device.

16. The device of claim 11, wherein the access limitations in the assigning step can include formatting preferences.

17. A system for managing contextual information, the system comprising:
a communication device having contextual information relating to the communication device;
a content provider that can request contextual information from the communication device for modifying content for presentation by the communication device; and
a communication infrastructure that facilitates communication between the communication device and the content provider;
the communication device maps access limitations to various content providers to control access to the contextual information, and filters requests for contextual information with the access limitations to identify contextual information that is permissible to be viewed by any particular content provider.

18. The system of claim 17, wherein the contextual information is stored in one or more of: locally in the communication device and remotely in the communication infrastructure.

19. The system of claim 17, wherein the communication infrastructure includes:
a control server that services the content provider,
a gateway that couples communication between the communication devices and the control server,
a set of over-the-air protocols for facilitating communication between the communication device and the gateway, and
a set of network protocols for facilitating communication between the gateway and the content provider.

20. The system of claim 17, wherein the access limitations include rules that are dependant on one or more of the group of: location of the communication device, environment of the communication device, existing applications running on the communication device, and time of day.
